(19) United States
(12) Patent Application Publication
(10) Pub. No.: US 2005/0081204 A1
(43) Pub. Date: Apr. 14, 2005

(54) Method and system for dynamically bounded spinning threads on a contested mutex

(75) Inventor: Joel Howard Schopp, Austin, TX (US)

Correspondence Address: Joseph R. Burwell;Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 10/671,122

(22) Filed: Sep. 25, 2003

(51) Int. Cl. G06F 9/46

(52) U.S. Cl. 718/100

(57) ABSTRACT

A method for managing a mutex in a data processing system is presented. For each mutex, a count is maintained of the number of threads that are spinning while waiting to acquire a mutex. If a thread attempts to acquire a locked mutex, then the thread enters a spin state or a sleep state based on restrictive conditions and the number of threads that are spinning during the attempted acquisition. In addition, the relative length of time that is required by a thread to spin on a mutex after already sleeping on the mutex may be used to regulate the number of threads that are allowed to spin on the mutex.

### BACKGROUND OF THE INVENTION

1. Field of the Invention

The present invention relates to an improved data processing system and, in particular, to a method and apparatus for multiple process coordinating. Still more particularly, the present invention provides a method and apparatus for process scheduling or resource allocation during task management or control using mutual exclusion locks (mutexes).

2. Description of Related Art

Modern operating systems support multiprogramming, whereby multiple programs appear to execute concurrently on a single computational device with a single central processing unit (CPU) or possibly multiple CPUs in a symmetric multiprocessor (SMP) machine. The appearance of concurrent execution is achieved through the use of serialized execution, also known as “time slicing”: the operating system of a device allows one of the multiple programs to execute exclusively for some limited period of time, i.e., a time slice, which is then followed by a period of time for the exclusive execution of a different one of the multiple programs. Because the switching between programs occurs so quickly, it appears that the programs are executing concurrently even though they are actually executing serially. When the time slice for one program is concluded, that program is put into a suspended or “sleep” state, and another program “awakes” and begins to execute.

One way of improving the performance of a single program or a single process is to divide the program or the process into paths of execution, often termed “threads”, that appear to execute concurrently. Such a program or process is typically described as “multitasking” or “multithreaded”; the operating system provides each thread with a time slice during which it has exclusive use of the CPU. Operating systems typically provide built-in mechanisms for switching between concurrent programs and/or threads in a very quick and efficient manner; some types of CPUs provide direct hardware support to an operating system for multithreading. Because the concepts of the present invention apply equally to concurrent threads and concurrent programs, which may comprise a single thread or multiple threads, the term “thread” as used herein may refer to a non-multithreaded program or to one thread within a multithreaded program.

As threads execute, they invariably need to access resources within a data processing system, such as memory, data structures, files, or other resources. Resources that are intended to be shared by multiple threads must be shared in such a way to protect the integrity of the data that is contained within the resource or that passes through the resource; one way of effecting this is by means of serializing execution of threads that are competing for a shared resource. When a first thread is already using a resource, a second thread that requires the resource must wait until the resource is no longer being used, which would typically occur as a consequence of the first thread having successfully completed its use of the resource.

An operating system typically provides multiple mechanisms for coordinating the use of shared resources by multiple threads. Although an application developer could create her own specific mechanisms for ensuring serialized access to shared resources, an application developer usually employs the mechanisms that are provided by an operating system or within a standardized software library to embed control logic for sharing resources into multiple threads. The use of operating-system-specific mechanisms is advantageous because it allows an operating system to integrate information about the competition for resources into its time slicing functionality. Hence, an operating system allocates time slices to threads in accordance with their needs and their competition for resources rather than through the use of strictly periodic time slices.

A common mechanism for serializing access to a shared resource is a mutex, or mutual exclusion lock, which is a simple lock having two states: locked and unlocked. The lock is typically implemented as a data object or a data structure that is created, destroyed, or modified via a software subroutine or module in a standardized library of routines. A mutex can be logically associated with a shared resource such that a thread that successfully locks the mutex is said to be the current owner of the mutex; only the thread that possesses a particular mutex should proceed to access the shared resource that is associated with that particular mutex, and only the thread that possesses a particular mutex should unlock that particular mutex. Thus, a critical section of code within a thread that accesses a shared resource is bounded by a call to lock a mutex and a call to unlock the same mutex. If a thread attempts to lock a mutex and fails, then it must wait until it is able to lock the mutex before proceeding to execute its critical section of code in which it accesses the shared resource. A mutex can be used to synchronize threads within a single process or across multiple processes if the mutex is allocated within memory that is shared by the coordinating processes.

The manner in which a thread waits for a mutex after failing to acquire the mutex depends on the manner in which the mutex mechanism is implemented. Three types of locks are widely used: a blocking lock, a spin lock, and some type of combination of a blocking lock and a spin lock. If a mutex has already been acquired and another thread requests to lock the mutex, then a mutex that is implemented as a blocking lock causes the waiting thread to cease being executable or to be suspended, i.e., to go to “sleep”. In contrast, spin locks do not put waiting threads to sleep. Instead, a waiting thread executes a loop, thereby repeatedly requesting the lock until it is freed by the thread that currently owns the mutex; the loop may contain an empty, iterative loop, i.e., “busy loop” or “busy wait”, that increments or decrements a variable such that the thread does not immediately re-request the mutex but waits for a period of time that depends on the length of the iterative loop.

In contrast to a blocking lock or a spin lock, a mutex is often implemented as a spin lock with a timeout, which is a lock that combines the characteristics of a blocking lock with the characteristics of a spin lock. A spin lock with a timeout spins for a limited period of time while allowing the thread to attempt to re-acquire the lock; if the limited period of time expires without acquiring the lock, then the thread is blocked. The time period for the timeout is usually controlled by executing a fixed number of iterations in a busy-wait loop. In addition to a lock routine and an unlock routine, software libraries often contain a “trylock” subroutine in which control is returned to the requesting subroutine if the mutex is not acquired, i.e., the requesting routine is not forced to wait for the mutex to become available.

The actions of blocking and spinning have their advantages and disadvantages. Blocking quickly suspends the execution of a waiting thread, but the action of blocking may suspend a thread that would soon acquire the lock, and the suspension of a thread entails relatively significant overhead, e.g., the thread's execution context must be saved. On the other hand, spinning consumes resources, such as CPU time and memory cache lines, but if the length of the spinning period is selected judiciously, then a waiting thread may often acquire a mutex relatively quickly, thereby allowing a spinning operation to consume less computational resources than a blocking operation.

The choice between spinning and blocking depends on many factors, particularly the computational environment of the device on which a thread is executing. Therefore, it would be advantageous to dynamically adjust the manner in which a thread chooses between spinning and blocking on a mutex. It would be particularly advantageous to provide a thread with the ability to consider the current characteristics of a contested mutex when the thread is choosing between spinning and blocking on a contested mutex.

### SUMMARY OF THE INVENTION

A method for managing a mutex in a data processing system is presented. For each mutex, a count is maintained of the number of threads that are spinning while waiting to acquire a mutex. If a thread attempts to acquire a locked mutex, then the thread enters a spin state or a sleep state based on restrictive conditions and the number of threads that are spinning during the attempted acquisition. In addition, the relative length of time that is required by a thread to spin on a mutex after already sleeping on the mutex may be used to regulate the number of threads that are allowed to spin on the mutex.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 2A depicts a block diagram that shows a logical organization of components within a typical multithreaded application that employs mutexes;

FIG. 2B depicts a block diagram that shows a logical organization of components in a typical data processing system that supports the execution of multithreaded applications that use mutexes that are supported by an operating system kernel;

FIG. 3 depicts a typical implementation of a spin lock mutex;

FIG. 4 depicts a block diagram that shows a mutex data structure that has been extended to include information for supporting an adaptive mutex in accordance with an embodiment of the present invention;

FIG. 5A depicts a flowchart that shows a process through which a thread is able to lock a mutex that is in an unlocked state while possibly branching for additional processing in accordance with an embodiment of the present invention;

FIG. 5B depicts a flowchart that shows an execution block in which the number of threads that may spin on a locked mutex is limited by a configurable threshold value;

FIG. 5C depicts a flowchart that shows an execution block in which a thread spins or busy-waits on a locked mutex;

FIG. 5D depicts a flowchart that shows an execution block in which a thread sleeps on a locked mutex;

FIG. 5E depicts a flowchart that shows an execution block in which a thread may acquire a mutex while dynamically adjusting the limiting value on the number of threads that may spin on a locked mutex; and

FIG. 6 depicts a flowchart that shows a process through which a thread releases an adaptive mutex.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

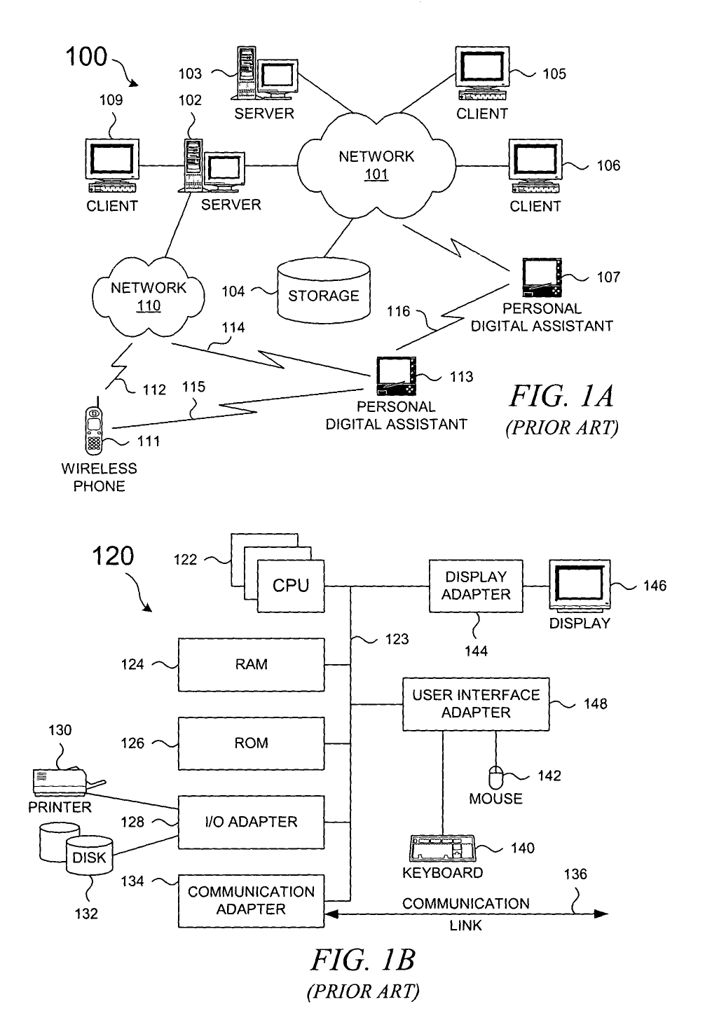

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP) Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B, including a symmetric multiprocessor (SMP) machine. Although all of the components that are shown within FIG. 1A and FIG. 1B are not required by the present invention, these elements may be used by a component in which the present invention is embedded, e.g., an operating system, an application, or some other component. In addition, the present invention may be implemented in a computational environment in which various components, such as display devices, are used indirectly to support the present invention, e.g., to allow configuration of parameters and elements by a system administrator.

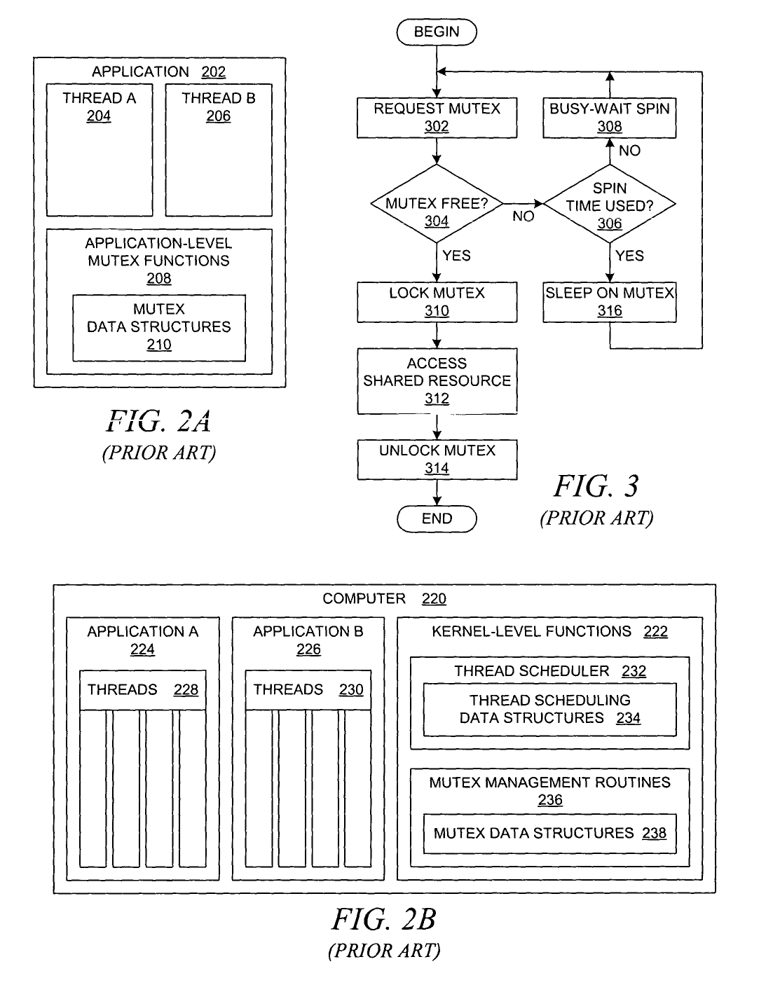

More specifically, though, the present invention is directed to an improved mutex, which may be implemented within an operating system, within an application, or in some other manner within a data processing system. Prior to describing the improved mutex in more detail, the use of a typical mutex is illustrated. As noted above, an application developer may create application-specific mutexes, as illustrated in FIG. 2A, but an application developer usually employs the mechanisms that are provided by an operating system or within a standardized software library, as illustrated in FIG. 2B. The present invention may be implemented in various application-specific or non-application-specific forms without affecting the scope of the present invention.

With reference now to FIG. 2A, a block diagram typical multithreaded application that employs mutexes. Multithreaded application 202 comprises multiple threads, such as thread 204 and thread 206. Rather than relying on mutex functions that might be provided by an operating system or within a standardized software library, such as the POSIX™ “pthread” library, an application may implement its own mutex functions 208, which are supported by mutex data structures 210, in order to serialize the operations of its own threads with respect to a resource that is shared by the threads that comprise the application.

With reference now to FIG. 2B, a block diagram depicts a logical organization of components on a typical data processing system that supports the execution of multithreaded applications that use mutexes that are supported by an operating system kernel. Computer 220 supports an operating system which contains kernel-level functions 222, which control the execution of multithreaded applications 224 and 226, which comprise threads 228 and 230, respectively. Thread scheduler 232 within the kernel determines when a thread runs and when it is suspended using thread scheduler data structures 234, which may contain data structures for assisting in the management of thread scheduling tasks; for example, the data structures may include FIFO (first-in, first-out) queues, such as queues that are associated with various thread states, e.g., a ready-to-execute queue, a sleeping queue, an I/O blocked queue, a mutex-waiting queue, or other states. Mutex management routines 236 that reside within the kernel (or routines as kernel extensions that execute with kernel-level privileges) provide functionality for creating, modifying, and destroying mutexes as reflected within mutex data structures 238. Hereinbelow, the term “sleep” is considered to be equivalent to any form of “suspension”.

With reference now to FIG. 3, a typical implementation of a spin lock mutex is depicted. The process begins when a thread requests to acquire a mutex (step 302); hereinbelow, the terms of “acquiring”, “reserving”, “possessing”, “owning”, or otherwise “locking” a mutex are regarded as being equivalent. A determination is made as to whether the mutex is free and unlocked (step 304), and if not, then a check is made as to whether a configurable amount time has been used by the thread by spinning on the mutex (step 306). If not, then the thread performs a busy-wait loop (step 308), i.e., it spins in a loop, as it waits for the mutex to become available; if the thread has already been through steps 302-308 previously, then the thread continues to perform the spinning operation by completing another busy-wait loop. After spinning for some period of time, the thread then repeats step 302.

If the mutex is free at step 304, then the mutex is locked on behalf of the thread (step 310), and the thread may proceed to access a shared resource (step 312) without the possibility of colliding with another thread and compromising the integrity of the data that is associated with the shared resource. After the thread has performed its operations with respect to the shared resource, then the thread requests that the mutex should be released, and the mutex is unlocked (step 314), thereby concluding the process. After the mutex has been unlocked, the mutex can be used by other concurrently executing threads. If a configurable amount time has already been used by the thread by spinning on the mutex as determined at step 306, then the thread sleeps on the mutex (step 316), e.g., by calling a kernel function that causes the thread to be put into a sleep state. The thread may sleep for a configurable period of time, or the kernel may have the ability to wake the thread when the mutex has been unlocked. In any case, after the thread is awakened, the thread again attempts to acquire the mutex.

Turning now to the present invention, the present invention is directed to a process for acquiring a contested mutex that is dynamically adaptive, on a per-mutex basis, to the current resources that are being consumed by multiple threads that are attempting to acquire the contested mutex. The remaining figures hereinbelow illustrate various embodiments of the present invention.

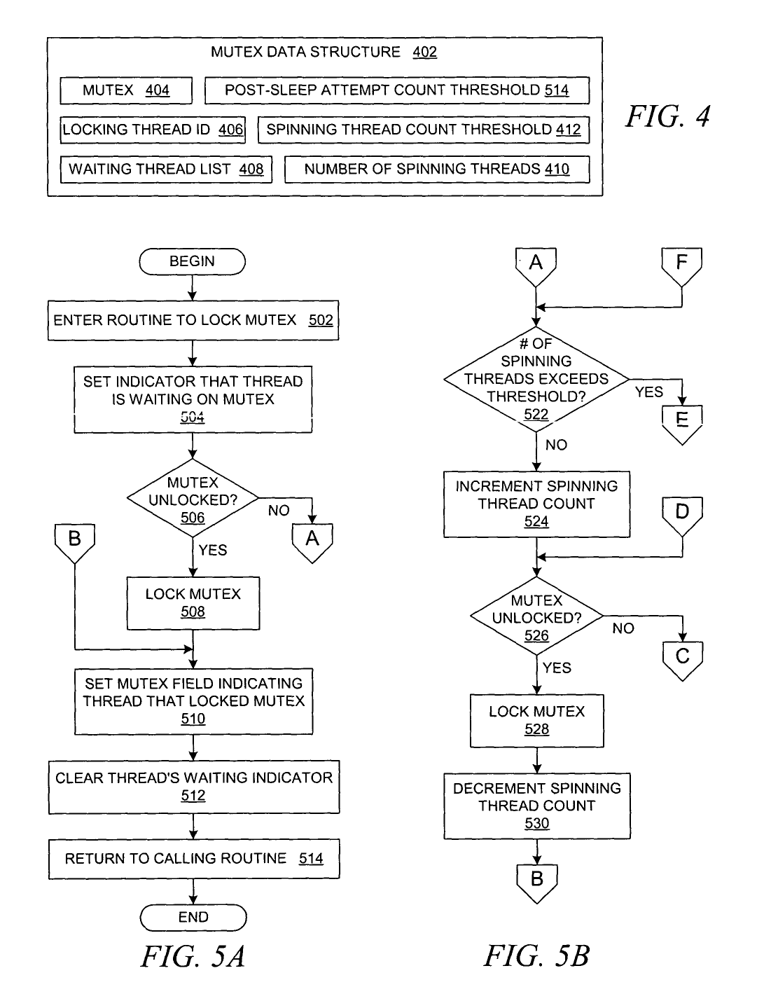

With reference now to FIG. 4, a block diagram depicts a mutex data structure that has been extended to include information for supporting an adaptive mutex in accordance with an embodiment of the present invention. It should be noted that the informational data items in the depicted mutex data structure may be stored in other data structures, and the mutex data structure in FIG. 4 is merely an example of a logical organization of various informational data items that may be logically associated with each other in support of an embodiment of the present invention; other informational data items may be included in the mutex data structure.

Mutex data structure 402 contains mutex 404, which is the data value that is toggled to reflect the locked or unlocked state of the mutual exclusion lock. If the mutex is locked, locking thread identifier 406 indicates the thread identifier that was assigned by the operating system to the thread that currently possesses the mutex, i.e., that has locked the mutex. If the mutex is locked and there are threads that are waiting for its release, i.e., spinning or sleeping on the mutex, then waiting thread list 408 contains the thread identifiers of the threads that are waiting for the release of the mutex. Alternatively, waiting thread list 408 may contain a list of records, wherein each record represents a thread that is waiting on the mutex, and each record may contain thread management information.

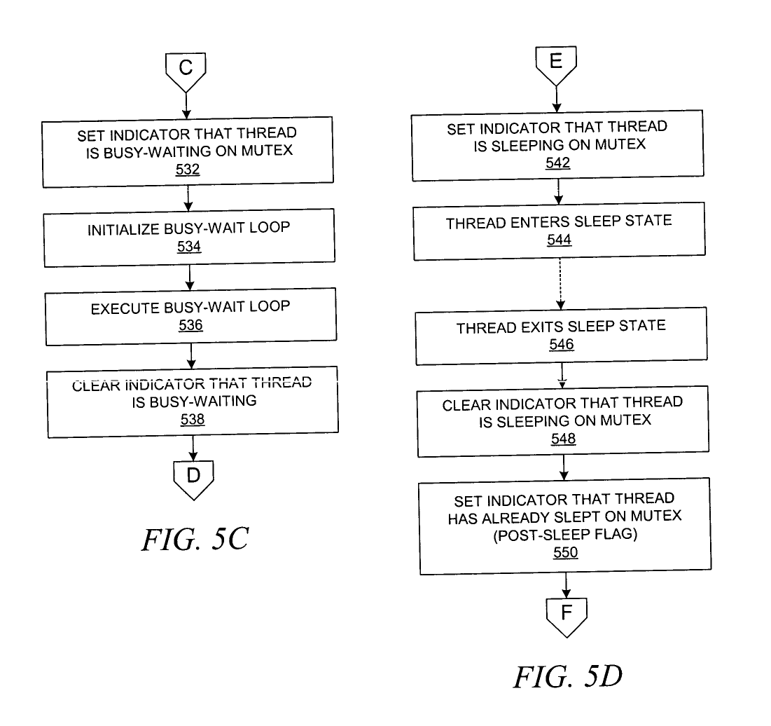

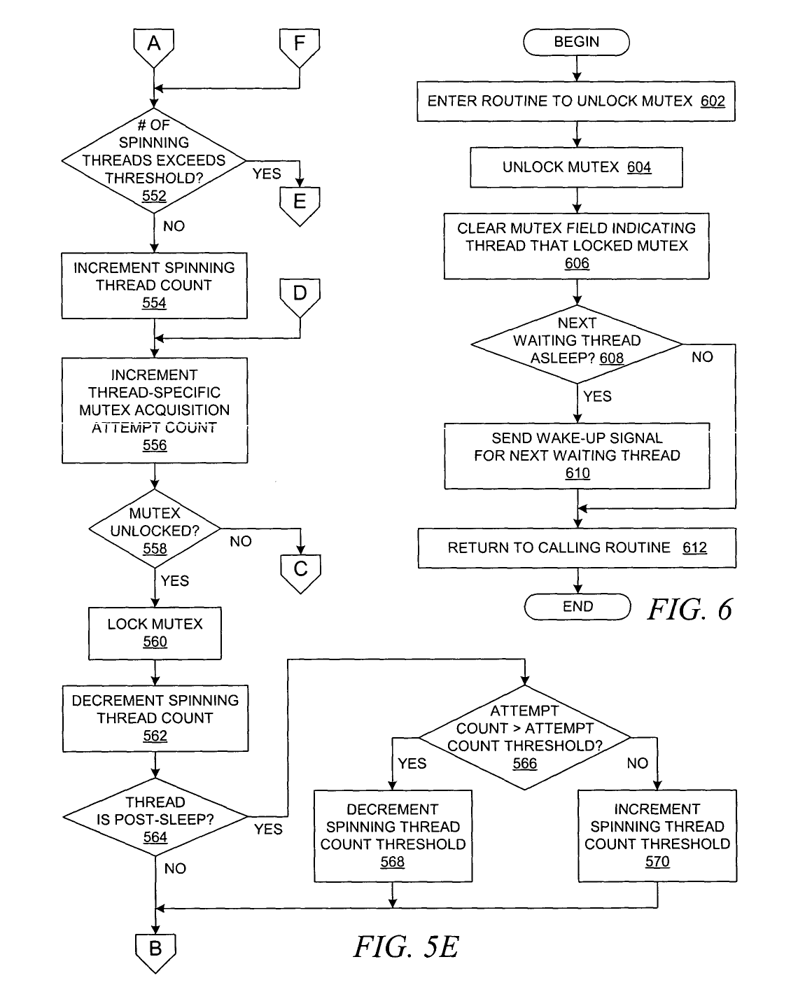

Mutex data structure 402 also contains data value 410 that represents the number of threads that are spinning on the mutex. If a thread enters a spin state while waiting for the release of the mutex, then the number of spinning threads is incremented. If a thread acquires the mutex, then the thread exits the spin state, and the number of spinning threads is decremented. Data value 412 represents a threshold on the number of threads that may be spinning at any given time while waiting for the release of the mutex. If this limit is reached, a thread may no longer enter a spin state while waiting for the mutex, as explained in more detail further below. In an alternative embodiment, mutex data structure 402 may also contain data value 414 that represents a post-sleep mutex acquisition attempt count threshold; the use of this threshold value is explained in more detail below with respect to FIG. 5E.

With reference now to FIG. 5A, a flowchart depicts a process through which a thread is able to lock a mutex that is in an unlocked state while possibly branching for additional processing in accordance with an embodiment of the present invention. FIGS. 5A-5E illustrate different portions of the processing that may occur while a thread is attempting to acquire a mutex. The flowchart in FIG. 5A represents a type of initial processing that may occur when a thread calls a routine while trying to acquire a mutex. From the flowchart in FIG. 5A, the processing may branch to the other flowcharts that are shown in FIGS. 5B-5E, but each of the other flowcharts is illustrated such that the processing concludes within FIG. 5A.

Referring to FIG. 5A, the process begins when a routine to lock an adaptive mutex is entered (step 502), e.g., when it is called from within a particular thread. In this example, the routine may be referred to as the “mutex management routine”, which may exist as a kernel-level routine that is accessed through a special operating system call or as some other type of routine that can only be run with special privileges. Alternatively, an application may implement an embodiment of the present invention, in which case the mutex management routine may be compiled into the object code of the application.

In order to reflect the most current state of the thread, e.g., for the benefit of a thread scheduler, a flag value is set to indicate that the thread is waiting on the mutex (step 504). Various other thread-specific data values may also be initialized.

A determination is then made as to whether or not the mutex is already locked (step 506). If the mutex is not already locked, then the mutex is locked on behalf of the thread (step 508). It should be noted that step 508 and step 510 should be implemented as an atomic operation, i.e., as an operation that cannot be interrupted; various well-known techniques exist for performing atomic operations with respect to a mutex.

In order to reflect the most current state of the thread, a thread identifier is stored in any data structures as needed to indicate the identity of the thread that has acquired the mutex (step 510), and the waiting flag value is cleared to indicate that the thread is no longer waiting on the mutex (step 512). The mutex management routine then returns to the calling routine (step 514), and the process of acquiring the mutex is concluded.

With reference now to FIG. 5B, a flowchart illustrates an execution block in which the number of threads that may spin on a locked mutex is limited by a configurable threshold value. The execution block that is illustrated within the flowchart in FIG. 5B represents some processing that may occur after a mutex is determined to be locked at step 506 in FIG. 5A.

Referring now to FIG. 5B, the execution block begins with a determination of whether or not the number of threads that are already spinning on the mutex has reached a maximum value (step 522). A mutex management data structure may contain a current total number of threads that have already entered a spin state while waiting for this particular mutex, and the mutex management data structure may also contain a mutex-specific spinning thread count threshold value, e.g., as shown in FIG. 4. If the limit on the number of spinning threads has already been reached, then the processing branches to the execution block that is shown in FIG. 5D so that the thread enters a sleep state rather than entering a spin state.

If the limit on the number of spinning threads has not already been reached as determined at step 522, then the thread may enter a spin state while waiting for the locked mutex to become available. The data value that represents the number of spinning threads within the mutex management data structure is then incremented to reflect that another thread has entered a spin state on the mutex (step 524). It should be noted that step 522 and step 524 should be implemented as an atomic operation; the check and the update of the spinning thread count would be performed as a single operation that cannot be interrupted in case two or more threads are performing this check at a given time.

A determination is then made as to whether or not the mutex remains locked (step 526). If so, then the thread spins on the mutex. The thread may spin on the mutex by entering a tight loop on step 526; the thread may repeatedly check whether the mutex has been unlocked, and if not, then the thread branches immediately back to step 526. Alternatively, as shown in FIG. 5B, a more intensive spin may be executed; the thread may branch to the execution block that is illustrated within FIG. 5C in which the thread executes a configurable busy-wait loop.

If the mutex is determined at step 526 to be unlocked, which may occur after the thread has spun on the mutex for some period of time, then the mutex is locked on behalf of the thread (step 528). Again, it should be noted that step 526 and step 528 should be implemented as an atomic operation. After acquiring the mutex, the thread is no longer in a spin state. Hence, the data value that represents the number of spinning threads within the mutex management data structure is then decremented (step 530). The execution block is concluded, thereafter returning to step 510 in FIG. 5A.

With reference now to FIG. 5C, a flowchart illustrates an execution block in which a thread spins or busy-waits on a locked mutex. The execution block that is illustrated within the flowchart in FIG. 5C represents some processing that may occur after a mutex is determined to be locked at step 526 in FIG. 5B.

Referring now to FIG. 5C, the execution block begins by setting a flag value to indicate that the thread is spinning or busy-waiting on the mutex (step 532), thereby reflecting the most current state of the thread. A busy-wait loop is then initialized, if necessary (step 534), and the busy-wait loop is entered, executed, and completed (step 536). For example, the busy-wait loop may comprise an empty iterative loop that does not perform any substantially useful work other than checking the state of the lock and optionally attempting to aquire the lock. Since the thread has completed the busy-wait loop, the flag value that indicates that the thread is spinning or busy-waiting on the mutex is cleared (step 538), thereby reflecting the most current state of the thread. The execution block is concluded, thereafter returning to step 526 in FIG. 5B. In an alternative embodiment, the busy-wait loop that is shown in FIG. 5C may include a configurable busy-wait timeout that limits the amount of busy-waiting that a thread performs, and if the thread reaches this limit, then the thread enters a sleep state.

With reference now to FIG. 5D, a flowchart illustrates an execution block in which a thread sleeps on a locked mutex. The execution block that is illustrated within the flowchart in FIG. 5D represents some processing that may occur after a mutex has determined at step 522 in FIG. 5B that the maximum number of spinning threads has already been reached.

Referring now to FIG. 5D, the execution block begins by setting a flag value to indicate that the thread is sleeping on the mutex (step 542), thereby reflecting the most current state of the thread. The thread then enters a sleep state for a period of time (step 544). The thread may sleep for a pre-configured period of time, but preferably, the thread sleeps until awoken by a targeted wake-up signal from another thread or in some other manner, e.g., by an action of the thread scheduler.

At some point in time, the thread exits the sleep state (step 546). Since the thread has completed the sleep cycle, the flag value that indicates that the thread is sleeping on the mutex is cleared (step 548), thereby reflecting the most current state of the thread.

As an optional step, a post-sleep flag may be set to indicate that the thread has already slept on the mutex while waiting to acquire the mutex (step 550); the post-sleep flag may have been initialized when the thread initially entered the mutex management routine to attempt to acquire the mutex, e.g., at step 502 in FIG. 5A. The significance of the post-sleep flag is explained in more detail further below with respect to an alternative embodiment of the present invention that is illustrated within FIG. 5E. The execution block is concluded, thereafter returning to step 522 in FIG. 5B.

Referring again to FIG. 5B, with the present invention, a thread performs various actions in accordance with the current computational environment of the mutex. More specifically, it should be apparent that when a thread is attempting to acquire a mutex, its behavior is dependent upon the current number of threads that are already spinning on the mutex and the limiting value or threshold on the maximum number of threads that are allowed to spin on the mutex at any given time. In this manner, the present invention ensures that a sufficient number of threads are spinning on a mutex to reduce the latency in acquiring the mutex, i.e., a mutex is acquired as soon as possible if more than one thread is waiting on the mutex. In addition, extraneous spinning is reduced because only a limited number of threads are allowed to spin on the mutex while other threads are put to sleep.

For a majority of workloads, the spinning thread count threshold could be set to a value of one such that only a single thread would spin on a mutex at any given time. However, there may be cases in which this threshold may need to be set a larger value to avoid serialized wake-up as a bottleneck. For example, if the mutex is highly contested and is held for a period of time that is shorter than the period of time that is required for a thread to sleep and awake, then threads would be going to sleep when they would otherwise quickly acquire the mutex if they had been spinning. In this scenario, it would be preferable to have more than one spinning thread.

In an alternative embodiment, the threshold limit on the number of spinning threads is dynamically adjustable. When a thread begins to spin on a mutex after the thread has already slept on the mutex, the thread monitors the length of time that it spins before acquiring the mutex. If the thread acquires the mutex relatively quickly after waking up, then the spinning thread count threshold may be increased, thereby ensuring that a sufficient number of threads are spinning on the mutex so that the mutex is acquired as soon as possible after its release. Conversely, if the thread spins excessively after waking up, then the spinning thread count threshold may be decreased, although the spinning thread count threshold would have a lower limit value of one. In this manner, the mutex adapts itself during runtime to the computational behavior of its environment.

With reference now to FIG. 5E, a flowchart illustrates an execution block in which a thread may acquire a mutex while dynamically adjusting the limiting value on the number of threads that may spin on a locked mutex in accordance with an embodiment of the present invention. The execution block that is illustrated within the flowchart in FIG. 5E represents some processing that may occur after a mutex is determined to be locked at step 506 in FIG. 5A. FIG. 5E is somewhat similar to FIG. 5B; some of the steps in FIG. 5E are the same as some of the steps in FIG. 5B, and the processing in FIG. 5E may branch to the execution blocks in FIG. 5C and FIG. 5D. However, FIG. 5E represents an alternative embodiment for the execution block that is shown in FIG. 5B; when the process branches at step 506 in FIG. 5A, either the execution block in FIG. 5B or FIG. 5E would be executed, but not both.

Referring now to FIG. 5E, the execution block begins with a determination of whether or not the number of threads that are already spinning on the mutex has reached a maximum value (step 552). If the limit on the number of spinning threads has already been reached, then the processing branches to the execution block that is shown in FIG. 5D so that the thread enters a sleep state rather than entering a spin state.

If the limit on the number of spinning threads has not already been reached as determined at step 552, then the thread may enter a spin state while waiting for the locked mutex to become available. The data value that represents the number of spinning threads within the mutex management data structure is then incremented to reflect that another thread has entered a spin state on the mutex (step 554). Again, it should be noted that step 552 and step 554 should be implemented as an atomic operation.

Before a determination is then made as to whether or not the mutex remains locked, i.e., before attempting the operation that actually acquires the mutex, a data value is incremented that represents a thread-specific, mutex acquisition attempt count (step 556). The mutex acquisition attempt count is a data value that is thread-specific; it may be maintained on a per-thread basis as a local variable within the thread's execution context. In other words, the mutex acquisition attempt count is not a thread-global data value that might be maintained within a mutex-specific mutex management data structure. The mutex acquisition attempt count may be initialized when the thread initially enters the mutex management routine to attempt to acquire the mutex, e.g., at step 502 in FIG. 5A; the data value that represents the count may be initialized to a value of one so that the value accurately reflects the initial attempt to acquire the mutex at step 506 in FIG. 5A. The use of the mutex acquisition attempt count is explained in more detail further below.

A determination is then made as to whether or not the mutex remains locked (step 558). If so, then the thread spins on the mutex. The thread may spin on the mutex by entering a tight loop on steps 556 and 558; the thread may repeatedly check whether the mutex has been unlocked, and if not, then the thread branches immediately back to step 556. Alternatively, as shown in FIG. 5E, a more intensive spin may be executed; the thread may branch to the execution block that is illustrated within FIG. 5C in which the thread executes a configurable busy-wait loop.

It the mutex is determined at step 558 to be unlocked, which may occur after the thread has spun on the mutex for some period of time, then the mutex is locked on behalf of the thread (step 560). Again, it should be noted that step 558 and step 560 should be implemented as an atomic operation. After acquiring the mutex, the thread is no longer in a spin state. Hence, the data value that represents the number of spinning threads within the mutex management data structure is then decremented (step 562).

At this point, FIG. 5E differs significantly from FIG. 5B by illustrating an embodiment in which the limit on the number of spinning threads is implemented as a dynamically adjustable value. A determination is made as to whether or not the thread has entered a sleep state while waiting on the mutex (step 564). For example, at step 550 in FIG. 5D, a post-sleep flag would have been set to indicate that the thread has already slept on the mutex while waiting to acquire the mutex. If the thread did not enter a sleep state, then the execution block is concluded, thereafter returning to step 510 in FIG. 5A. If the thread did enter a sleep state, then the limit on the number of spinning threads is adjusted in the following steps.

A determination is made as to whether or not the thread has attempted to acquire the mutex more than a limiting value (step 566). The count of the number of attempts to acquire the mutex is gathered at step 556 upon each attempt; this is a thread-specific or thread-relative value. The post-sleep mutex acquisition attempt count threshold is a mutex-specific value; e.g., it may be maintained within a mutex-specific data structure, such as that shown in FIG. 4.

If the comparison of the number of mutex acquisition attempts by the post-sleep thread is greater than the post-sleep mutex acquisition attempt count threshold, then the thread has spun for a relatively long time before acquiring the mutex, so the spinning thread count threshold is decremented (step 568). If the comparison of the number of mutex acquisition attempts by the post-sleep thread is less than the post-sleep mutex acquisition attempt count threshold, then the thread has spun for a relatively short time before acquiring the mutex, so the spinning thread count threshold is incremented (step 570). Although not shown in the figures, there may be an upper limit on the maximum possible number of spinning threads, wherein the upper limit would be dependent on the resources that are available to support the threads. Furthermore, the spinning thread count threshold may be increased or decreased by some value other than a value of one, i.e., rather than incrementing or decrementing by a value of one. In addition, the values that are used to increase or decrease the spinning thread count threshold may be dynamically computed in accordance with the values of other resources that are available to support the spinning threads.

The post-sleep mutex acquisition attempt count threshold may be a configurable value that is mutex-specific, application-specific, or possibly system-specific such that is used for each mutex that is supported within a given system. Moreover, the post-sleep mutex acquisition attempt count threshold may be dynamically adjustable in accordance with resource availability.

In an alternative embodiment, the post-sleep mutex acquisition attempt count threshold may be replaced by two threshold values that represent a lower threshold value and an upper threshold value. The outcome of the comparison of the number of mutex acquisition attempts with a lower value for the post-sleep mutex acquisition attempt count threshold would regulate when the spinning thread count threshold would be increased. The outcome of the comparison of the number of mutex acquisition attempts with an upper value on the post-sleep mutex acquisition attempt count threshold would regulate when the spinning thread count threshold would be decreased. If the number of mutex acquisition attempts fell between the two threshold values, then the spinning thread count threshold would not be adjusted. Other algorithms for adjusting the spinning thread count threshold may be implemented in various embodiments of the present invention.

In the alternative embodiment that is illustrated within FIG. 5E, the threshold limit on the number of spinning threads Is dynamically adjustable. The outcome of the comparison of the number of mutex acquisition attempts by the post-sleep thread with the post-sleep mutex acquisition attempt count threshold at step 566 provides a determination of whether or not there are a sufficient number of threads that are spinning on the mutex. As mentioned above, in some scenarios, it may be preferable to have more than one spinning thread at any given time.

When a thread begins to spin on a mutex after the thread has already slept on the mutex, the thread monitors the length of time that it spins before acquiring the mutex; this is performed at step 556 by maintaining a count of the number of mutex acquisition attempts, but other computational cost metrics could be maintained in other embodiments of the present invention.

A scenario in which the thread acquires the mutex relatively quickly after waking up is determined by a relatively small mutex acquisition attempt count value; this is accounted for by a negative outcome at step 566. For this case, the spinning thread count threshold may be increased to ensure that a sufficient number of threads are spinning on the mutex; this is represented by step 570.

Conversely, a scenario in which the thread spins excessively after waking up is determined by a relatively large mutex acquisition attempt count value; this is accounted for by a positive outcome at step 566. For this case, the spinning thread count threshold may be decreased to ensure that too many threads are not spinning on the mutex, which is represented by step 568, although the spinning thread count threshold would have a lower limit value of one. In this manner, the mutex adapts itself during runtime to the computational behavior of its environment.

With reference now to FIG. 6, a flowchart depicts a process through which a thread releases an adaptive mutex. FIG. 6 complements FIGS. 5A-5E by showing a thread that is releasing a mutex that was previously acquired using the processes that are shown in FIGS. 5A-5E. The process begins when a routine to unlock a mutex is entered (step 602). After checking to ensure that the thread that is requesting to unlock the mutex is the thread that has previously locked the mutex, the mutex is then unlocked (step 604); it should be noted that step 604 should be implemented as an atomic operation. The routine then clears or deletes any thread identifiers that were previously stored in a data structure to indicate the identity of the thread that previously locked the mutex (step 606).

A determination is then made as to whether or not any threads that have been waiting for the mutex are sleeping on the mutex (step 608). If so, then a thread that is sleeping on the mutex is sent a wake-up signal (step 610), e.g., through a system call that will schedule the thread for execution. If multiple threads are sleeping on the mutex, then an appropriate algorithm may be used to select the next thread that should attempt to lock the mutex. The unlocking routine then returns to the calling routine (step 612), thereby concluding the process of unlocking the mutex.

The advantages of the present invention should be apparent in view of the detailed description that is provided above. In the prior art, when a mutex is locked, a thread would typically perform a spin timeout operation on the locked mutex, which causes the thread to sleep after a period of time that is configurable at the system level or the application level. With the present invention, the determination of whether the thread should spin or sleep on a locked mutex is dependent upon the computational environment that surrounds that particular mutex. The present invention adjusts the behavior of a thread with respect to a particular locked mutex so that the thread enters a spin state or enters a sleep state in a manner that is dependent upon previous actions of other threads with respect to the mutex.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A method for managing a mutex in a data processing system, the method comprising:
maintaining a spinning thread count value for a number of threads that are spinning on a mutex;
attempting to acquire the mutex by a first thread; and
in response to a determination that the mutex has already been acquired by a second thread, determining to enter a spin state or a sleep state on the first thread based on the spinning thread count value.

2. The method of claim 1 further comprising:
entering a spin state if the spinning thread count value satisfies a first condition; and
entering a sleep state if the spinning thread count value satisfies a second condition.

3. The method of claim 2 wherein the first condition is that the spinning thread count value is less than a spinning thread count threshold value.

4. The method of claim 2 wherein the second condition is that the spinning thread count value is greater than or equal to a spinning thread count threshold value.

5. The method of claim 2 further comprising:
comparing the spinning thread count value with a spinning thread count threshold value to select a spin state or a sleep state.

6. The method of claim 5 further comprising:
adjusting the spinning thread count threshold value based on an amount of time that is required by a thread to acquire the mutex after sleeping on the mutex.

7. The method of claim 5 further comprising:
adjusting the spinning thread count threshold value based on a number of acquisition attempts that is required by a thread to acquire the mutex after sleeping on the mutex.

8. The method of claim 5 further comprising:
decreasing the spinning thread count threshold value if a thread acquires the mutex relatively slowly after sleeping on the mutex.

9. The method of claim 5 further comprising:
increasing the spinning thread count threshold value if a thread acquires the mutex relatively quickly after sleeping on the mutex.

10. A computer program product on a computer readable medium for use in a data processing system for managing a mutex, the computer program product comprising:
means for maintaining a spinning thread count value for a number of threads that are spinning on a mutex;
means for attempting to acquire the mutex by a first thread; and
means for determining to enter a spin state or a sleep state on the first thread based on the spinning thread count value in response to a determination that the mutex has already been acquired by a second thread.

11. The computer program product of claim 10 further comprising:
means for entering a spin state if the spinning thread count value satisfies a first condition; and
means for entering a sleep state if the spinning thread count value satisfies a second condition.

12. The computer program product of claim 11 wherein the first condition is that the spinning thread count value is less than a spinning thread count threshold value.

13. The computer program product of claim 11 wherein the second condition is that the spinning thread count value is greater than or equal to a spinning thread count threshold value.

14. The computer program product of claim 11 further comprising:
means for comparing the spinning thread count value with a spinning thread count threshold value to select a spin state or a sleep state.

15. The computer program product of claim 14 further comprising:
means for adjusting the spinning thread count threshold value based on a number of acquisition attempts that is required by a thread to acquire the mutex after sleeping on the mutex.

16. The computer program product of claim 14 further comprising:
means for decreasing the spinning thread count threshold value if a thread acquires the mutex relatively slowly after sleeping on the mutex.

17. The computer program product of claim 14 further comprising:
means for increasing the spinning thread count threshold value if a thread acquires the mutex relatively quickly after sleeping on the mutex.

18. An apparatus for managing a mutex, the apparatus comprising:
means for maintaining a spinning thread count value for a number of threads that are spinning on a mutex;
means for attempting to acquire the mutex by a first thread; and
means for determining to enter a spin state or a sleep state on the first thread based on the spinning thread count value in response to a determination that the mutex has already been acquired by a second thread.

19. The apparatus of claim 18 further comprising:
means for entering a spin state if the spinning thread count value is less than a spinning thread count threshold value; and
means for entering a sleep state if the spinning thread count value is greater than or equal to a spinning thread count threshold value.

20. The apparatus of claim 18 further comprising:
means for comparing the spinning thread count value with a spinning thread count threshold value to select a spin state or a sleep state; and
means for adjusting the spinning thread count threshold value based on a number of acquisition attempts that is required by a thread to acquire the mutex after sleeping on the mutex.
